(19) United States
(12) Patent Application Publication
(10) Pub. No.: US 2008/0292378 A1
(43) Pub. Date: Nov. 27, 2008

(54) Doctor device and blade exchange method for doctor device

(75) Inventor: Yoshihiko Aikawa, Shizuoka-shi (JP)

Correspondence Address: KANESAKA BERNER AND PARTNERS LLP, 1700 DIAGONAL RD, SUITE 310, ALEXANDRIA, VA, 22314-2848, US

(73) Assignee: AIKAWA IRON WORKS CO., LTD., Shizuoka-shi (JP)

(21) Appl. No.: 12/076,889

(22) Filed: Mar. 25, 2008

(30) Foreign Application Priority Data
Mar. 30, 2007 (JP) 2007-90789

(51) Int. Cl. G03G 21/00

(52) U.S. Cl. 399/351

(57) ABSTRACT

A doctor device includes a blade contacting a roll, a blade holder for holding the blade, and a moving device for moving the blade in such a direction that the blade moves toward the roll or away from the roll. The blade includes a first blade edge located on a side contacting the roll and a second blade edge located on a side opposite to the first blade edge. The blade holder includes an upper member supporting a portion of an upper surface of the blade, and a lower member supporting a portion of an under surface of the blade. The blade is held by the upper member and the lower member in such a state that the first blade edge of the blade projects from the blade holder, and the second blade edge of the blade does not contact the blade holder.

### BACKGROUND OF THE INVENTION AND RELATED ART STATEMENT

The present invention relates to a doctor device and a blade exchange method for the doctor device, especially, a doctor device and the blade exchange method for the doctor device which can promptly exchange a blade and utilize the blade efficiently.

Conventionally, in a doctor device used for a finisher and the like in a paper manufacturing machine such as a paper machine, coater, winder and the like, the blade contacts a roller and eliminates foreign material and residue attached to the roller (for example, refer to FIG. 2 in Japanese Unexamined Patent Publication No. 2001-254288).

In the above-mentioned doctor device, the blade contacts the roller, so that when the blade is worn out, the blade has to be replaced. Therefore, the abraded blade is discarded, and resources are not effectively utilized.

The purpose of the present invention is to provide a doctor device and blade exchange method for a doctor device enabling to solve the above-mentioned problem.

Further objects and advantages of the invention will be apparent from the following description of the invention.

### SUMMARY OF INVENTION

A doctor device of the present invention includes a blade contacting a roll; a blade holder holding the blade; and moving means for making the blade revolve in such a direction that the blade moves toward the roll or away from the roll. The blade is provided with a first blade edge which is located on a side contacting the roll; and a second blade edge which is located on a side opposite to the first blade edge.

The doctor device according to a second aspect of the invention includes, in the doctor device according to the first aspect of the invention, a blade holder provided with an upper member on which one portion of the upper surface of the blade is abutted and-supported; and a lower member on which a part of the under surface of the blade is abutted and supported. The blade is held by the upper member and the lower member in a state wherein the first blade edge of the blade projects from the blade holder, and the second blade edge of the blade does not contact the blade holder.

The doctor device according to a third aspect of the invention, in the doctor device according to the first or second aspect of the invention, is provided with a projection projecting toward the lower side from the under surface of the blade. The blade has a longitudinal shape and the projection is provided so as to cross the longitudinal direction of the blade. The distance between the first blade edge and the center of the projection is identical to the distance between the second blade edge and the center of the projection. A depression which opens upwardly is provided on the lower member, and the projection is engaged in the depression.

The doctor device according to a fourth aspect of the invention, in the doctor device according to the first or second aspect of the invention, is provided with a projection which projects toward the upper side from the upper surface of the blade. The blade has a longitudinal shape and the projection is provided so as to cross the longitudinal direction of the blade. The distance between the first blade edge and the center of the projection is identical to the distance between the second blade edge and the center of the projection. A depression which opens downwardly is provided on the-upper member, and the projection is engaged in the depression.

The doctor device according to a fifth aspect of the invention, in the doctor device according to the first or second aspect of the invention, is provided with multiple projections projecting toward the lower side from the under surface of the blade. The blade has a longitudinal shape and the multiple projections are provided so as to cross the longitudinal direction of the blade. The distance between the first blade edge and the center of the projection on the side near the first blade edge is identical to the distance between the second blade edge and the center of the projection on the side near the second blade edge. A depression which opens upwardly is provided on the lower member, and the projection is engaged in the depression.

The doctor device according to a sixth aspect of the invention, in the doctor device according to the first or second aspect of the invention, is provided with multiple projections projecting toward the upper side from the upper surface of the blade. The blade has an elongated shape, and the multiple projections are provided so as to cross the longitudinal direction of the blade. The distance between the first blade edge and the center of the projection on the side near the first blade edge is identical to the distance between the second blade edge and the center of the projection on the side near the second blade edge. The depression which opens downwardly is provided on the upper member, and the projection is engaged in. the depression.

A blade exchange method for the doctor device according to a seventh aspect of the invention comprises the blade contacting the roll; the blade holder for holding the blade; and the moving means for moving the blade in such a direction that the blade moves toward the roll or away from the roll. The blade is provided with the first blade edge which is located on the side contacting the roll; and the second blade edge located on the side opposite to the first blade edge. After the first blade edge of the blade contacting the roll is abraded, the blade is removed from the blade holder, and the blade is held by the blade holder in such a way that the second blade edge contacts the roll.

According to the doctor device of the first aspect, after the first blade edge of the blade contacting the roll is abraded, the blade is removed from the blade holder, and the blade is held by the blade holder in such a way that the second blade edge contacts the roll. As a result, the blade can be promptly exchanged and the blade can be effectively utilized.

According to the doctor device of the second aspect, in addition to the effect of the invention of the first aspect, the blade is held by the upper and lower members in a state where the second blade edge of the blade does-not contact the blade holder. As a result, the second blade edge of the blade can be protected.

According to the doctor device of the third aspect, in addition to the effect of the invention of the first or second aspect, the projection is provided on the under surface of the blade so as to project toward the lower side. The blade has a longitudinal shape and the projection is provided so as to cross the longitudinal direction of the blade. The distance between the first blade edge and the center of the projection is identical to the distance between the second blade edge and the center of the projection. The depression which opens upwardly is provided on the lower member, and the projection is engaged in the depression. As a result, the blade can be prevented from being displaced, and even after the second blade edge is attached to the blade holder after the first blade edge is abraded, a mismatch regarding a positional relationship between the first blade edge and the second blade edge can be prevented, so that it is easier to adjust the position.

According to the doctor device of the fourth aspect, in addition to the effect of the invention of the first or second aspect, the projection is provided on the upper surface of the blade so as to project toward the upper side. The blade has a longitudinal shape and the projection is provided so as to cross the longitudinal direction of the blade. The distance between the first blade edge and the center of the projection is identical to the distance between the second blade edge and the center of the projection. The depression which opens downwardly is provided on the upper member, and the projection is engaged in the depression. As a result, the blade can be prevented from being displaced, and even after the second blade edge is attached to the blade holder when the first blade edge is abraded, a mismatch regarding a positional relationship between the first blade edge and the second blade edge can be prevented, so that it is easier to adjusted the position.

According to the doctor device of the fifth aspect, in addition to the effect of the invention of the first or second aspect, the multiple projections are provided on the under surface of the blade in such a way as to project toward the lower side. The blade has the elongated shape and the multiple projections are provided so as to cross the longitudinal direction of the blade. The distance between the first blade edge and the center of the projection on the side near the first blade edge is identical to the distance between the second blade edge and the center of the projection on the side near the second blade edge. The depression which opens upwardly is provided on the lower member, and the projection is engaged in the depression. As a result, the blade can be prevented from being displaced. Even after the second blade edge is attached to the blade holder when the first blade edge is abraded, a mismatch regarding a positional relationship between the first blade edge and the second blade edge can be prevented, so that it is easier to adjust the position.

According to the doctor device of the sixth aspect, in addition to the effect of the invention of the first or second aspect, multiple projections are provided on the upper surface of the blade so as to project toward the upper side. The blade has the elongated shape, and the multiple projections are provided so as to cross the longitudinal direction of the blade. The distance between the first blade edge and the center of the projection on the side near the first blade edge is identical to the distance between the second blade edge and the center of the projection on the side near the second blade edge. The depression which opens downwardly is provided on the upper member, and the projection is engaged in the depression. As a result, the blade can be prevented from being displaced, and even after the second blade edge is attached to the blade holder when the first blade edge is abraded, a mismatch regarding a positional relationship between the first blade edge and the second blade edge can be prevented, so that it is easier to adjust the position.

According to the blade exchange method for the doctor device of the seventh aspect, after the first blade edge of the blade contacting the roll is abraded, the blade is removed from the blade holder, and the blade is held by the blade holder in such a way that the second blade edge contacts the roll. As a result, the blade can be promptly exchanged, and the blade can be effectively utilized.

### BRIEF DESCRIPTION OF THE DRAWINGS

FIG. 1 is a schematic cross sectional view of a doctor device of an embodiment of the present invention;

FIG. 2 is a schematic partially enlarged sectional view wherein a portion in FIG. 1 is enlarged;

FIG. 3 is a schematic partially enlarged sectional view wherein a second blade edge of a blade in FIG. 2 is positioned on a roll side;

FIG. 4 is a schematic cross sectional view of the doctor device of another embodiment which differs from the doctor device in FIG. 1;

FIG. 5 is a schematic partially enlarged sectional view wherein a portion in FIG. 4 is enlarged;

FIG. 6 is a schematic partially enlarged sectional view in a state wherein the second blade edge of the blade in FIG. 5 is located on the roll side;

FIG. 7 is a schematic cross sectional view of another embodiment which differs from FIG. 2; and

FIG. 8 is a schematic cross sectional view of another embodiment which differs from FIG. 5.

### DETAILED DESCRIPTION OF PREFERRED EMBODIMENTS

An embodiment of a doctor device and a blade exchange method for the doctor device of the invention will be explained with reference to the drawings.

### Embodiment 1

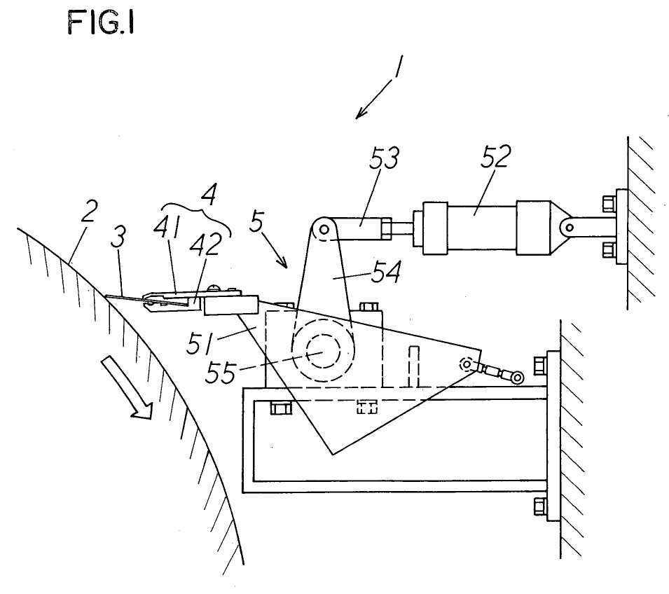

In FIGS. 1 to 3, the reference numeral 1 represents the doctor device. The doctor device 1 eliminates a foreign material and residue on a roller 2 by a blade 3, and is used for a finisher and the like in a paper manufacturing machine such as a paper machine, coater, winder and the like.

More specifically, the doctor device 1 comprises the blade 3 contacting the roll 2; a blade holder 4 for holding the blade 3; and moving means or device 5 for moving the blade holder 4 in such a direction that the blade holder 4 moves toward -the roll 2 or away from the roll 2.

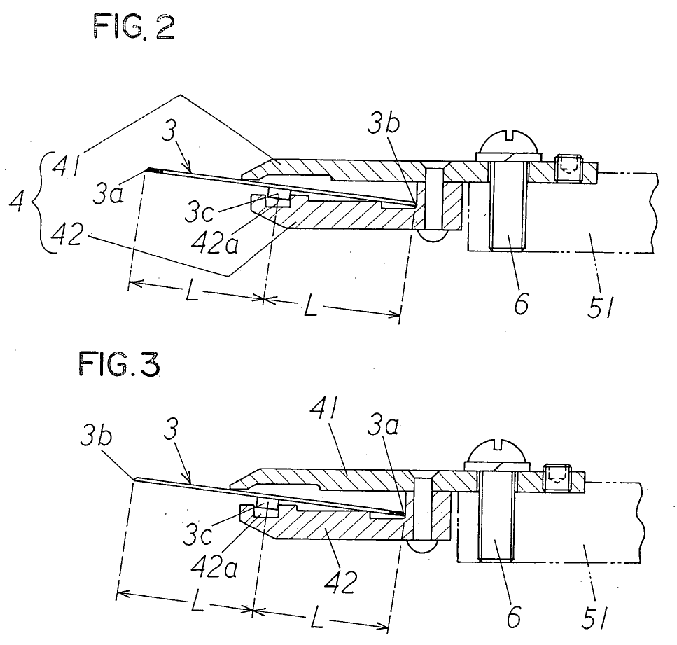

The blade 3 is provided with a first blade edge 3a which is located on the side contacting the roll 2; and a second blade edge 3b which is located on the side opposite to the first blade edge 3a (refer to FIGS. 2, 3).

In addition to that the first blade edge 3a which is located on the side contacting the roll 2 is provided in the blade 3, the second blade edge 3b is provided on the side opposite to the first blade edge 3a. Accordingly, after the first blade edge 3a of the blade 3 contacting the roll 2 is abraded, the blade 3 is removed from the blade holder 4, and the blade 3 is held by the blade holder 4 in such a way that the second blade edge 3b contacts the roll 2 (refer to FIG. 3). As a result, the blade 3 can be promptly exchanged, and effectively utilized.

Also, on the under surface of the blade 3, a projection 3c is provided in such a way as to project toward the lower side. The projection 3c is located in the middle between the first blade edge 3a and the second blade edge 3b.

More specifically, the blade 3 has a long elongated shape (the blade 3 has approximately a rectangle in a plan view) in a longitudinal direction of the roll 2. The projection 3c is provided so as to cross the longitudinal direction of the blade 3. The distance (length L) between the first blade edge 3a and the center of the projection 3c is identical to that (length L) between the second blade edge and the center of the projection (refer to FIGS. 2, 3).

The reason for this structure is, even if the second blade edge 3b is attached to the blade holder 4 after the first blade edge 3a is abraded, a mismatch regarding a positional relationship between the first blade edge 3a and the second blade edge 3b can be prevented, so that it is easier to adjust the position by exchanging the blade edge.

The blade holder 4 includes an upper member 41 on which a portion of the upper surface of the blade 3 is abutted and supported; and a lower member 42 on which a portion of the under surface of the blade 3 is abutted and supported. The upper member 41 is supported by a doctor back 51 through a screw 6.

The lower member 42 is provided with a depression 42a which opens upwardly, and the projection 3c is engaged in the depression 42a, so that the blade 3 is prevented from displacement.

Also, the blade 3 is held by the upper member 41 and the lower member 42 in a state where the first blade edge 3a of the blade 3 projects from the blade holder 4 and the second blade edge 3b of the blade 3 does not contact the blade holder 4.

As a result, the second blade edge 3b of the blade 3 can be protected, and portions of the blade 3 except the first blade edge 3a and the second blade edge 3b can be held by the upper member 41 and the lower member 42.

Incidentally, in the embodiment, the projection 3c is provided on the under surface of the blade 3 in such a way as to project toward the lower side. However, although it is not shown, the projection may be provided on the upper surface of the blade 3 in such a way as to project toward the upper side. In such a case, the depression is provided on the upper member 41 in such a way as to open downwardly and engaged in a projection (not shown) which is provided on the upper surface of the blade 3 and projects toward the upper side.

The moving means 5 makes the blade 3 move toward the roll 2 or away from the roll 2. For example, the moving means 5 moves a piston 53 of a cylinder 52 back and forth, rotates an arm 54, and makes the blade 3 contact the roll 2 or move away from the roll 2 through an axis 55 and the doctor back 51.

Therefore, according to the doctor device 1 of the embodiment, when the doctor device 1 is used for a certain period of time and the first blade edge 3a (refer to FIGS. 1, 2) of the blade 3 contacting the roll 2 is abraded, the blade 3 is released from the blade holder 4 and held by the blade holder 4 in such a way that the second blade edge 3a faces the side contacting the roll 2 (refer to FIG. 3).

Thus, the blade 3 can be promptly exchanged and effectively utilized.

### Embodiment 2

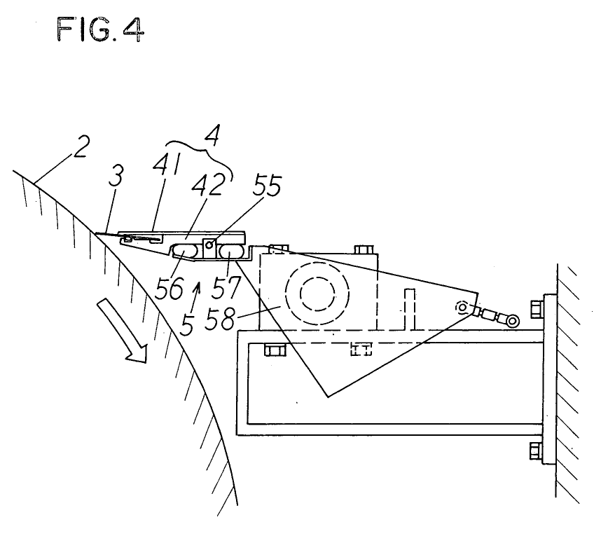

In the embodiment, as to the moving means 5 which makes the blade 3 move toward the roll 2 or away from the roll 2, the doctor back 51 is rotated using the cylinder 52, piston 53, and arm 54. However, the present invention is not limited to the above-mentioned embodiment. For example, as shown in FIGS. 4 to 6, the blade 3 may be rotated using a tube.

Incidentally, in the embodiment 2, the same symbols are assigned to the same or corresponding parts of the embodiment 1, and their explanations are partially omitted.

More specifically, the reference numeral 56 shown in FIGS. 4 to 6 represents a first tube, the reference numeral 57 represents a second tube, and the reference numeral 58 represents a doctor back which does not rotate.

In order to abut the blade 3 against the roll 2, air inside the first tube 56 is partially released, and the air inside the second tube 57 is pressurized. As shown in FIG. 5, the blade 3 is rotated counterclockwise. On the other hand, in order to move the blade 3 away from the roll 2, air inside the first tube 56 is pressurized, air inside the second tube is partially released, and the blade 3 is rotated clockwise which is opposite to FIG. 5.

The upper member 41, on which the portion of the upper surface of the blade 3 is abutted and supported, can be separated from the lower member 42 to which the portion of the under surface of the blade 3 is abutted and supported by a screw (not shown).

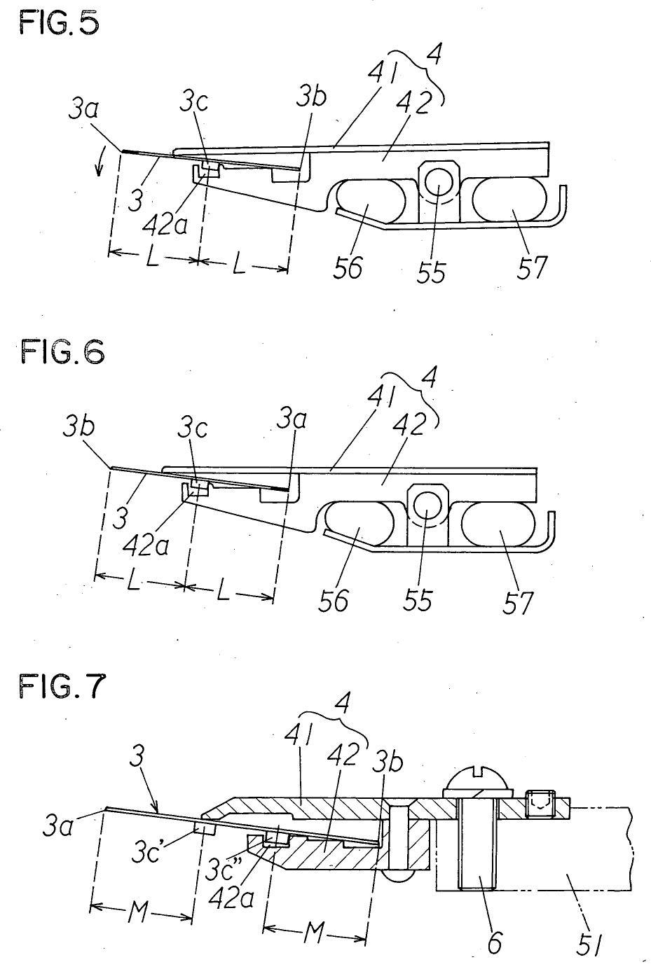

Even in this embodiment, as in the case of the above-mentioned embodiment, when the doctor device 1 is used for a certain period of time, and the first blade edge 3a (refer to FIGS. 4, 5) of the blade 3 contacting the roll 2 is abraded, the blade 3 is released from the blade holder 4 and held by the blade holder 4 in such a way that the second blade edge 3a faces the side contacting the roll 2 (refer to FIG. 6).

Thus, the blade 3 can be promptly exchanged and effectively utilized.

In the embodiment, one projection 3c is provided so as to cross the longitudinal direction of the blade 3. However, the present invention is not limited to the above-mentioned embodiment, and can be applied to an embodiment wherein multiple projections 3c are provided so as to cross the longitudinal direction of the blade 3.

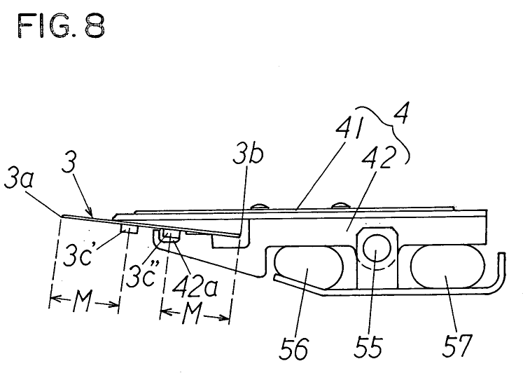

More specifically, the invention can be applied to the embodiment shown in FIG. 7 instead of FIG. 2, and the embodiment shown in FIG. 8 instead of FIG. 5.

Multiple projections 3c′, 3c″ (two projections in this embodiment) are provided on the under surface of the blade 3 in such a way as to project toward the lower side. The blade 3 has a long longitudinal shape as in the case of the blade 3 described beforehand. The multiple (in the embodiment, for example, two) projections 3c′, 3c″ are provided so as to cross the longitudinal direction of the blade 3. The distance (length M) between the first blade edge 3a and the center of the projection 3c′ on the side near the first blade edge 3a is identical to that (length M) between the second blade edge 3b and the center of the projection 3c″ on the side near the second blade edge 3b (refer to FIGS. 2, 3).

The lower member 42 is provided with the depression 42a which opens upwardly, and the projection 3c′ or 3c″ is engaged in the depression 42a, so that the blade 3 is prevented from displacement.

Incidentally, in the embodiment, multiple projections 3c′, 3c″ are provided on the under surface of the blade 3 in such a way as to project toward the lower side. However, although it is not shown, multiple projections may be provided on the upper surface of the blade 3 in such a way as to project toward the upper side. In such a case, depressions are provided on the upper member 41 in such a way as to open downwardly and locked with projections (not shown) which are provided on the upper surface of the blade 3 and project toward the upper side.

Also, the doctor device of the invention is not limited to a paper manufacturing machine such as the paper machine and the like, and can be applied to a doctor device for scraping off surplus ink or application attached to a cylinder such as a plate drum and the like in a gravure printer, coater and the like which are used for printing or coating.

The disclosure of Japanese Patent Application No. 2007-090789, filed on Mar. 30, 2007, is incorporated in the application.

While the invention has been explained with reference to the specific embodiments of the invention, the explanation is illustrative and the invention is limited only by the appended claims.

What is claimed is:

1. A doctor device, comprising:
a blade adapted to contact a roll;
a blade holder for holding the blade; and
a moving device for moving the blade in such a direction that the blade moves toward the roll or away from the roll,
wherein the blade includes a first blade edge located on a side of the roll and a second blade edge located on a side opposite to the first blade edge.

2. A doctor device according to claim 1, wherein the blade holder comprises an upper member supporting a portion of an upper surface of the blade; and a lower member supporting a portion of an under surface of the blade; and the blade is held by the upper and lower members in such a state that the first blade edge of the blade projects from the blade holder, and the second blade edge of the blade does not contact the blade holder.

3. A doctor device according to claim 2, wherein the blade comprises a projection provided on the under surface of the blade and projecting toward a lower side, the blade having an elongated shape; the projection is provided so as to cross a longitudinal direction of the blade; a distance between the first blade edge and a center of the projection is identical to a distance between the second blade edge and the center of the projection; and the lower member in the blade holder comprises a depression opening upwardly so that the projection is engaged in the depression.

4. A doctor device according to claim 2, wherein the blade comprises a projection provided on the upper surface of the blade and projecting toward an upper side, the blade having an elongated shape; the projection is provided so as to cross a longitudinal direction of the blade; a distance between the first blade edge and a center of the projection is identical to a distance between the second blade edge and the center of the projection; and the upper member in the blade holder comprises a depression opening downwardly so that the projection is engaged in the depression.

5. A doctor device according to claim 2, wherein the blade comprises multiple projections provided on the under surface of the blade and projecting toward a lower side, the blade having an elongated shape; the multiple projections are provided so as to cross a longitudinal direction of the blade; a distance between the first blade edge and a center of the projection on a side near the first blade edge is identical to a distance between the second blade edge and a center of the projection on the side near the second blade edge; and the lower member in the blade holder comprises a depression opening upwardly so that the projection is engaged in the depression.

6. A doctor device according to claim 2, wherein the blade comprises multiple projections provided on the upper surface of the blade and projecting toward an upper side, the blade having an elongated shape; the multiple projections are provided so as to cross a longitudinal direction of the blade; a distance between the first blade edge and a center of the projection on a side near the first blade edge is identical to a distance between the second blade edge and a center of the projection on a side near the second blade edge; and the upper member in the blade holder comprises a depression opening downwardly so that the projection is engaged in the depression.

7. A blade exchange method for the doctor device, comprising:
setting a first blade edge of a blade to contact a roll by a blade holder for holding the blade,
removing the blade from the blade holder after the first blade edge of the blade contacting the roll is abraded, and holding the blade by the blade holder such that a second blade edge at a side opposite to the first blade edge faces the side contacting the roll.
